(19) United States
(12) Patent Application Publication
(10) Pub. No.: US 2019/0149702 A1
(43) Pub. Date: May 16, 2019

(54) IMAGING APPARATUS

(71) Applicant: Panasonic Intellectual Property Management Co., Ltd., Osaka (JP)

(72) Inventors: Hiroyuki SATOH, Osaka (JP); Masato IZAWA, Osaka (JP); Yuichi SUZUKI, Osaka (JP); Yoshio OHTSUKA, Osaka (JP)

(21) Appl. No.: 16/184,309

(22) Filed: Nov. 8, 2018

(30) Foreign Application Priority Data
Nov. 10, 2017 (JP) 2017-217656

(51) Int. Cl. H04N 5/06; H04N 5/247

(52) U.S. Cl. CPC H04N 5/06; H04N 5/247

(57) ABSTRACT

An imaging apparatus includes an imager, a receiver, a synchronization signal generator, and a time code controller. The imager performs an imaging operation according to a synchronization signal. The receiver receives a time code signal including time code information and a synchronization pattern for detecting the time code information from another imaging apparatus. The synchronization signal generator generates the synchronization signal so as to be synchronized with a timing of the synchronization pattern included in the time code signal received. The time code controller generates a time code based on the synchronization signal and the time code information received.

### BACKGROUND

### 1. Technical Field

The present disclosure relates to an imaging apparatus.

### 2. Related Art

When videos shot using a plurality of imaging apparatuses are edited, capturing images at timings synchronized among the plurality of imaging apparatuses may be desired. Various techniques have been developed as a method of synchronizing capturing timings among a plurality of imaging apparatuses.

For example, Japanese Unexamined Patent Application Publication No. 2005-286453 discloses a surveillance camera capable of synchronizing video capturing timings among a plurality of surveillance cameras connected to each other via a network. The surveillance camera of Japanese Unexamined Patent Application Publication No. 2005-286453 is a surveillance camera connected to a network and provided with a synchronization reference counter and includes a synchronization information communication means for transmitting and receiving synchronization information about a synchronization signal as a reference of capturing timing via the network, a counter read value adjustment circuit for adjusting a read value of a synchronization reference counter based on the synchronization information, and a synchronization signal generation circuit for generating a synchronization signal based on the read value of the synchronization reference counter. With this configuration, synchronization information necessary to synchronize capturing timings among cameras connected to each other via a network is communicated to each other, the read values of the synchronization reference counters of all cameras constituting the system are adjusted so as to be the same at the same time based on the synchronization information, and each camera generates a synchronization signal from the adjusted read value of the synchronization reference counter. Thus, each camera shoots video in synchronization with the synchronization signal and therefore, all cameras can shoot the video at the shooting timing unified in the system.

### SUMMARY

According to a first aspect of the present disclosure, an imaging apparatus includes an imager, a receiver, a synchronization signal generator, and a time code controller. The imager performs an imaging operation according to a synchronization signal. The receiver receives a time code signal including time code information and a synchronization pattern for detecting the time code information from another imaging apparatus. The synchronization signal generator generates the synchronization signal so as to be synchronized with a timing of the synchronization pattern included in the time code signal received. The time code controller generates a time code based on the synchronization signal and the time code information received.

According to a second aspect of the present disclosure, an imaging apparatus includes an imager, a time code signal generator, a transmitter, and a synchronization signal generator. The imager performs an imaging operation according to a synchronization signal. The time code signal generator generates a time code signal including time code information and a synchronization pattern for detecting the time code information. The transmitter transmits the time code signal to another imaging apparatus. The synchronization signal generator generates the synchronization signal so as to be synchronized with a timing of the synchronization pattern included in the time code signal transmitted.

According to a third aspect of the present disclosure, an imaging system includes a first imaging apparatus and a second imaging apparatus. The first imaging apparatus performs an imaging operation according to a first video synchronization signal. The first imaging apparatus transmits a time code signal including time code information and a synchronization pattern for detection of the time code information. The first imaging apparatus generates the first video synchronization signal so as to be synchronized with the synchronization pattern included in the time code signal. The second imaging apparatus performs the imaging operation according to a second video synchronization signal. The second imaging apparatus generates the second video synchronization signal so as to be synchronized with the synchronization pattern included in the time code signal received from the first imaging apparatus.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings.

FIG. 1 is a diagram showing a configuration of an imaging system according to a first embodiment of the present disclosure.

FIG. 2 is a block diagram showing a specific configuration of imaging apparatuses (a master camera and a slave camera).

FIG. 3 is a diagram showing a format of a longitudinal time code (LTC) signal.

FIG. 4 is a diagram illustrating a state in which frame phases are not synchronized among a plurality of imaging apparatuses.

FIG. 5 is a diagram illustrating a state in which frame phases are synchronized among a plurality of imaging apparatuses in the imaging system according to the first embodiment of the present disclosure.

### DESCRIPTION OF THE EMBODIMENT

The embodiments will now be described with reference to the accompanying drawings, wherein like reference numerals designate corresponding or identical elements throughout the various drawings.

Hereinafter, embodiments will be described in detail with reference to the drawings as appropriate. However, unnecessary detailed descriptions may be omitted. For example, detailed descriptions of already well-known matters or redundant descriptions of substantially the same configuration may be omitted. This is intended to avoid making the following description unnecessarily redundant and to facilitate understanding by those skilled in the art.

In addition, the inventor(s) provide the accompanying drawings and the following description in order to enable those skilled in the art to sufficiently understand the present disclosure and the subject matter described in claims is not intended to be thereby limited.

### [1-1. Configuration]

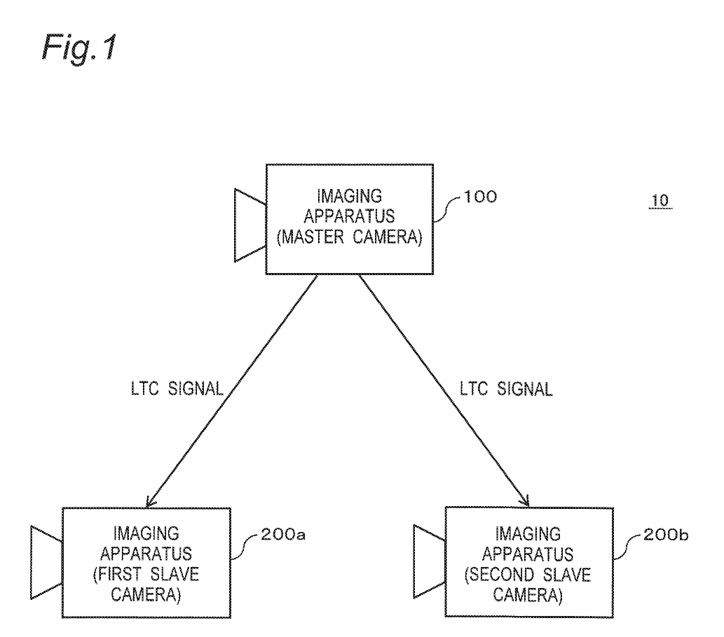

FIG. 1 is a diagram showing a configuration of an imaging system of the present disclosure. An imaging system 10 includes a plurality of imaging apparatuses 100, 200a, 200b. The imaging apparatuses 100, 200a, 200b can capture moving images or still images by temporally being synchronized.

The imaging apparatus 100 is an imaging apparatus that operates as a master in synchronization control among imaging apparatuses. Hereinafter, the imaging apparatus 100 will be referred to as a “master camera”. The imaging apparatuses 200a and 200b are imaging apparatuses that operate as slaves in synchronization control among imaging apparatuses. Hereinafter, the imaging apparatuses 200a and 200b will be referred to as a “first slave camera” and a “second slave camera” respectively. Further, there are cases where the first slave camera 200a and the second slave camera 200b are collectively referred to as “slave cameras 200”.

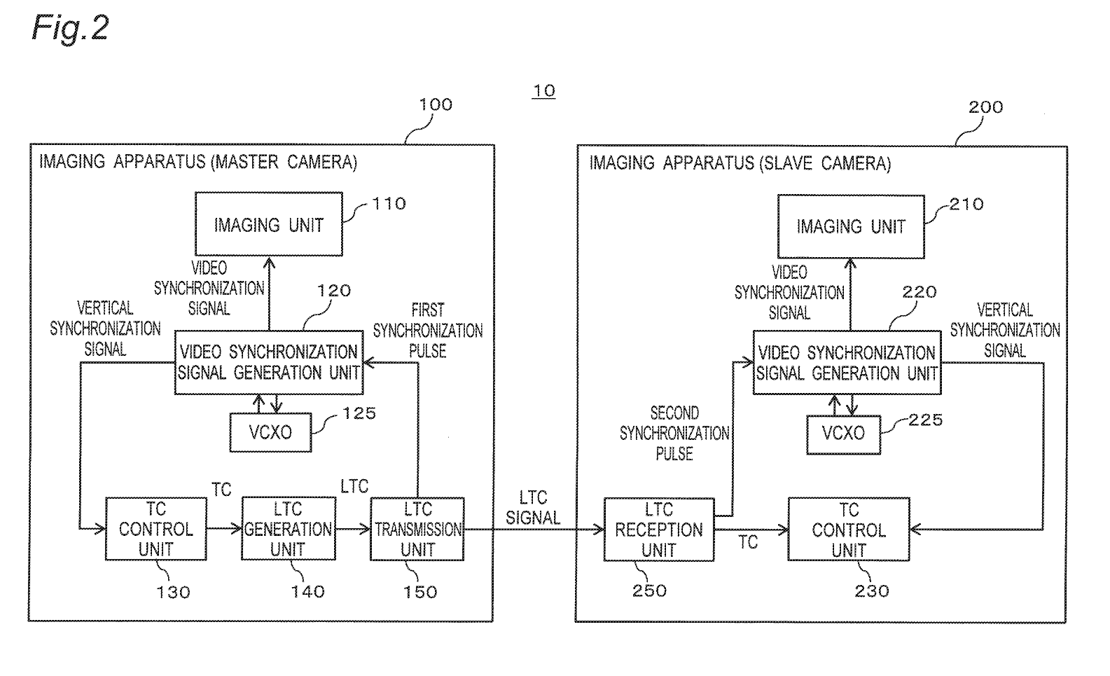

FIG. 2 is a block diagram showing a specific configuration of the master camera 100 and the slave camera 200. Note that FIG. 2 mainly shows the configuration related to the function related to the synchronization control between the master camera 100 and the slave camera 200a. The first slave camera 200a and the second slave camera 200b have configurations similar to each other.

As shown in FIG. 2, the master camera 100 includes an imaging unit 110 that captures an image of a subject to generate image data (moving images, still images), a video synchronization signal generation unit 120 that generates and outputs various synchronization signals for the imaging unit 110, a VCXO 125 as a voltage controlled crystal oscillator, a TC control unit 130 that controls a time code, an LTC generation unit 140 that generates an LTC signal, and an LTC transmission unit 150 that transmits a generated LTC signal to the slave camera.

The imaging unit 110 includes an image sensor such as a CCD or a CMOS image sensor. The imaging unit 110 converts an optical signal into an electric signal to generate image data. The imaging unit 110 also includes an optical system including a focus lens and a zoom lens.

The video synchronization signal generation unit 120 generates a video synchronization signal based on an internally generated clock signal. The video synchronization signal includes a vertical synchronization signal and a horizontal synchronization signal. In accordance with these video synchronization signals, the imaging unit 110 performs an imaging operation.

The VCXO 125 controls the frequency of the clock signal in the video synchronization signal generation unit 120.

The TC control unit 130 receives a vertical synchronization signal from the video synchronization signal generation unit 120, counts the time using an internal counter, and outputs a count value.

The LTC generation unit 140 receives the count value from the TC control unit 130 and generates an LTC signal using the received count value. Details of the LTC signal will be described below.

The LTC transmission unit 150 transmits the LTC signal to the slave camera 200 outside. Further, the LTC transmission unit 150 transmits a first synchronization pulse signal indicating the timing synchronized with a synchronization pattern contained in the LTC signal to the video synchronization signal generation unit 120. Details of the LTC signal and the first synchronization pulse signal will be described below.

The slave camera 200a includes an imaging unit 210 that captures an image of a subject to generate image data, a video synchronization signal generation unit 220 that generates and outputs various synchronization signals for the imaging unit 210, a VCXO 225 as a voltage controlled crystal oscillator, a TC control unit 230 that controls a time code, and an LTC reception unit 250 that receives an LTC signal from the master camera.

The imaging unit 210 includes an image sensor such as a CCD or a CMOS image sensor. The imaging unit 210 converts an optical signal into an electric signal to generate image data. The imaging unit 210 also includes an optical system including a focus lens and a zoom lens.

The video synchronization signal generation unit 220 generates a video synchronization signal including a vertical synchronization signal and a horizontal synchronization signal. The TC control unit 230 receives a vertical synchronization signal from the video synchronization signal generation unit 220 and counts the time to generate a time code (TC).

The VCXO 225 (an example of a clock adjuster) is a voltage controlled crystal oscillator and controls the frequency of a clock signal in the video synchronization signal generation unit 220.

The LTC reception unit 250 receives an LTC signal from the master camera 100. Further, the LTC reception unit 250 outputs a second synchronization pulse signal indicating the timing of a synchronization pattern contained in the received LTC signal. Details of the second synchronization pulse signal will be described below. Also, the LTC reception unit 250 extracts the time code (TC) contained in the LTC signal and transmits the extracted time code to the TC control unit 230.

Each of the master camera 100 and the slave camera 200 has a BNC connector (or an alternative connector). The master camera 100 and the slave camera 200 are connected by a BNC cable, and an LTC signal is transmitted therebetween via the BNC cable. Instead of the BNC cable, the LTC signal may be transmitted by wireless communication (radio waves or light).

In the master camera 100, the video synchronization signal generation unit 120, the TC control unit 130, the LTC generation unit 140, and the LTC transmission unit 150 may be configured with, for example, one or a plurality of CPUs or MPUs and the functions described below may be implemented through cooperation with predetermined software. Alternatively, the above units may be configured with one or more dedicated hardware circuits such as FPGA or ASIC.

Also in the slave camera 200, the video synchronization signal generation unit 220, the TC control unit 230, and the LTC reception unit 250 may be configured with, for example, one or a plurality of CPUs or MPUs and the functions described below may be implemented through cooperation with predetermined software. Alternatively, the above units may be configured with one or more dedicated hardware circuits such as FPGA or ASIC.

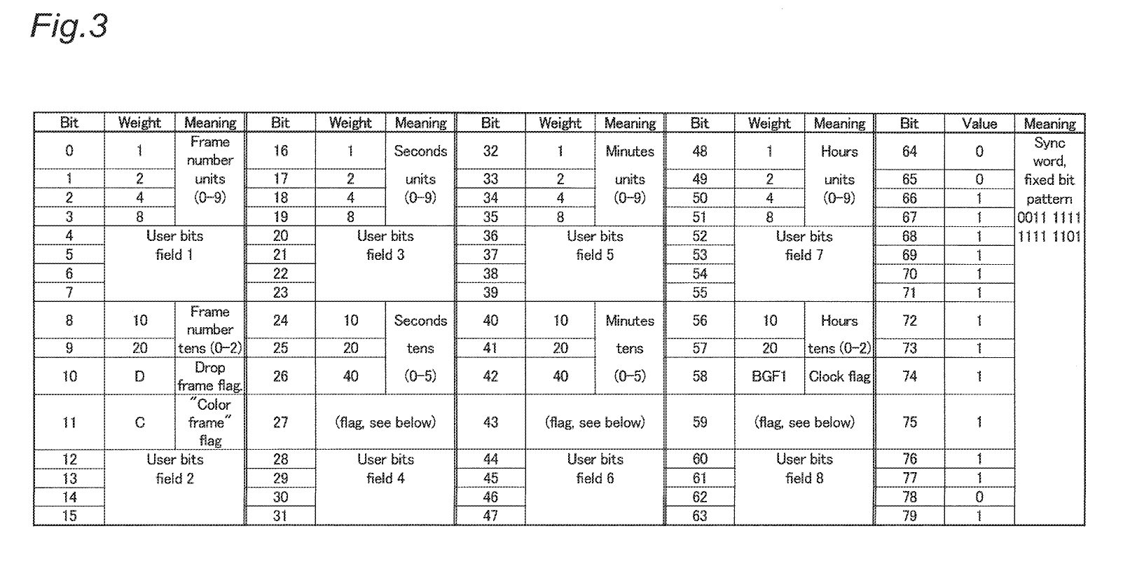

FIG. 3 is a diagram showing a format of an LTC signal transmitted between the master camera 100 and the slave camera 200. The LTC signal is a signal indicating a time code defined by the SMPTE 12 standard. The LTC signal is 80-bit serial data indicating time code information for each frame and is formed of 24.25 or 30 frames per second.

The LTC signal includes time information (time code) and a synchronization pattern. More specifically, the hour, minute, second, and frame number are stored as the time information (time code) of a frame in the 0-th to 63-rd bits of the LTC signal. In the 64-th to 79-th bits of the LTC signal, a synchronization pattern (Sync word) is stored. The synchronization pattern is made up of 16 bits including 12 consecutive “1”s. Further, the synchronization pattern includes “00” and “01” before and after the continuous 12 “1”s respectively. When the LTC signal is recorded on a tape medium, it is possible to determine the reproduction direction of the tape medium by recognizing the 2 bits (“00”, “01”).

As shown in FIG. 3, the synchronization pattern (Sync word) is added to the end of an LTC signal. The transmission of the LTC signal for 80 bits shown in FIG. 3 is set to 30 frames/second. The frame rate of the master camera 100 and the slave camera 200 in the present embodiment is set to 60 frames/second as an example of this time. Thus, one time code contained in the LTC signal for 80 bits indicates a time code allocated to a period of two frames. That is, by detecting the synchronization pattern (Sync word), a delimiter at every two frames can be detected.

Originally, the synchronization pattern (Sync word) in an LTC signal has been used to detect the position of a time code in order to decode the time code. On the other hand, in the present embodiment, the synchronization pattern is used not only for such an original purpose, but also for the purpose of synchronization between cameras.

### [1-2. Operation]

The synchronous operation between the master camera 100 and the slave cameras 200a and 200b will be described with respect to the imaging system 10 configured as described above.

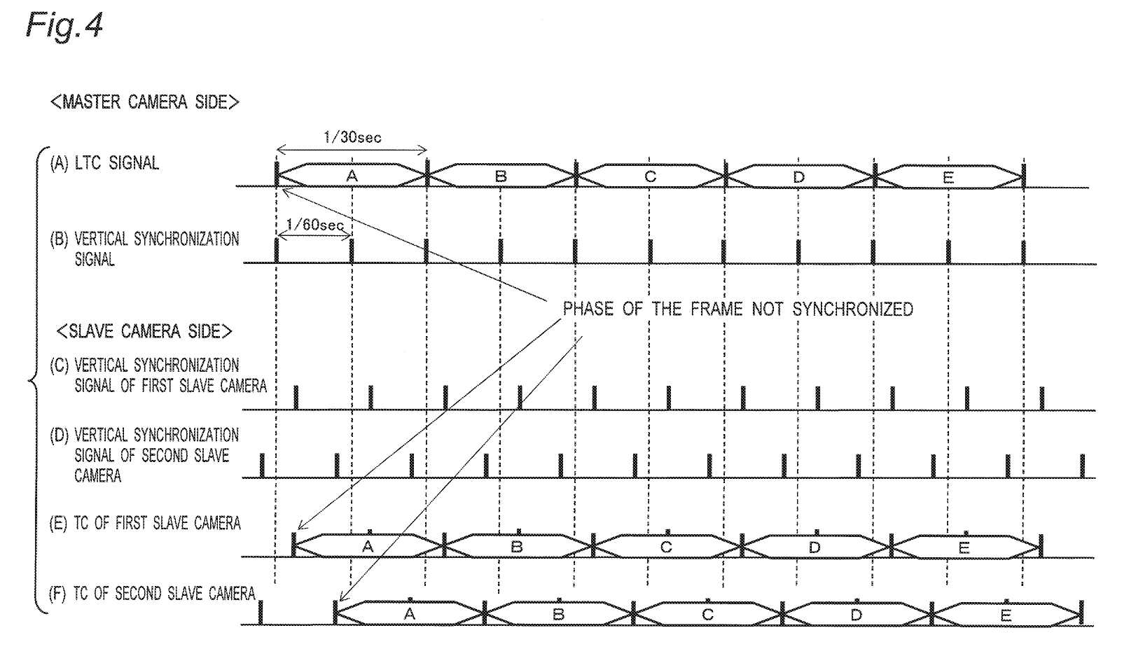

FIG. 4 is a diagram illustrating a state in which the master camera 100 and the slave cameras 200a and 200b are out of synchronization.

In FIG. 4, (A) shows an LTC signal generated in the master camera 100. In (A) of FIG. 4, time codes A, B, C, . . . are added every two frames. Also in FIG. 4, (B) shows a vertical synchronization signal in the master camera 100. In FIGS. 4, (C) and (D) show vertical synchronization signals in the first and second slave cameras 200a and 200b respectively when the synchronization is not established. In FIGS. 4, (E) and (F) show time codes (TC) added to a frame in the first and second slave cameras 200a and 200b respectively when the synchronization is not established.

As shown in (B), (C), and (D) of FIG. 4, the vertical synchronization signal is not synchronized between the master camera 100 and the slave cameras 200a and 200b, and a shift arises in the frame start position. When, in such a state, the time code is synchronized with a temporally close frame based on the LTC signal from the master camera 100 in the first and second slave cameras 200a and 200b, as shown in (E) and (F) of FIG. 4, the phase of the time code is shifted. That is, frames to which the same time code is added are out of phase. In this case, the phase of the frame may be shifted by one-half frame at the maximum.

In order to solve this problem, the imaging system 10 in the present embodiment performs synchronization control between the master camera 100 and the slave camera 200 to synchronize frame phases.

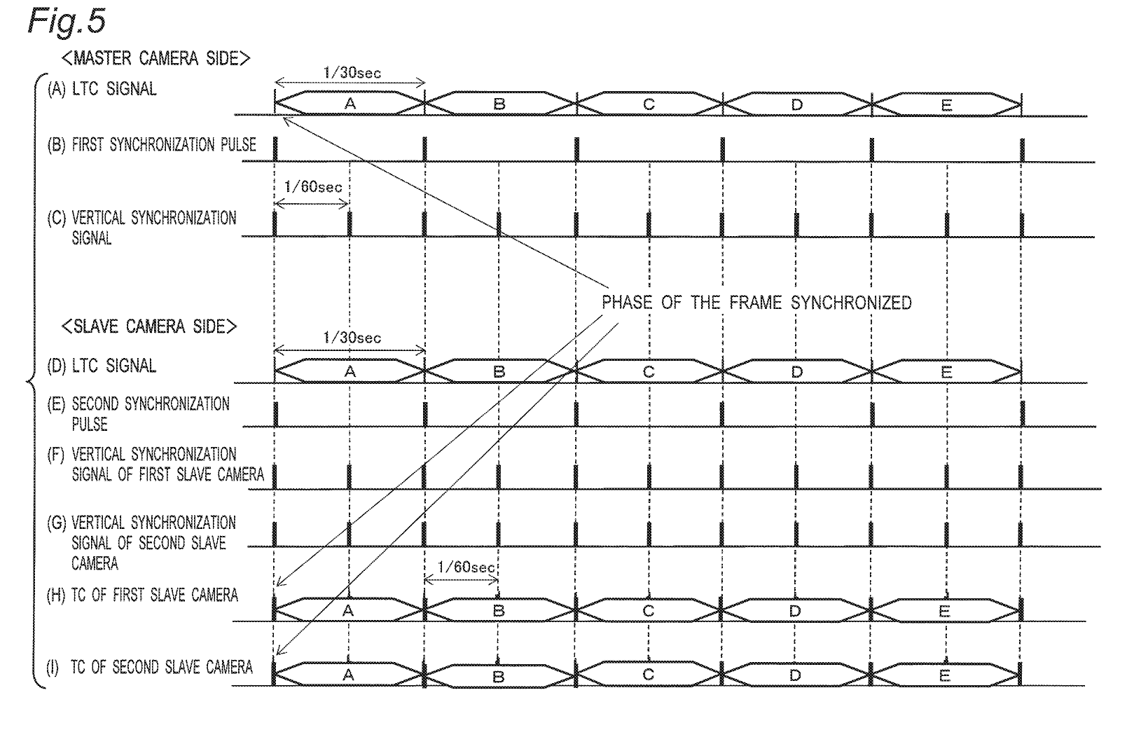

FIG. 5 is a diagram illustrating various signals generated in the imaging system 10 according to the present embodiment. In FIG. 5, (A) shows an LTC signal generated by the master camera 100. In FIG. 5, (B) shows a first synchronization pulse signal generated in the master camera 100. In FIG. 5, (C) shows a vertical synchronization signal in the master camera 100. In FIG. 5, (D) shows an LTC signal received by the first and second slave cameras 200a and 200b. In FIG. 5, (E) shows a second synchronization pulse signal generated in the first and second slave cameras 200a and 200b. In FIGS. 5, (F) and (G) are vertical synchronization signals in the first and second slave cameras 200a and 200b respectively when synchronization is established. In FIGS. 5, (H) and (I) show time codes (TC) added to the frame in the first and second slave cameras 200a and 200b respectively when synchronization is established.

According to the imaging system 10 in the present embodiment, as shown in (C), (F), and (G) of FIG. 5, the phases of vertical synchronization signals can be synchronized between the master camera 100 and the slave camera 200. Accordingly, as shown in (H) and (I) of FIG. 5, the time codes A, B, C, . . . in the first and second slave cameras 200a and 200b can be synchronized with the time code in the master camera 100 shown in (A) of FIG. 5. Thus, it is possible to synchronize the frame phases between the master camera 100 and the slave cameras 200a and 200b. By synchronizing the frame phases among a plurality of cameras in this way, it is possible to perform a shooting operation in which the exposure timings are synchronized.

A synchronous operation of the master camera 100 and the slave camera 200 to implement such frame phase synchronization will be described more specifically.

In the master camera 100 shown in FIG. 2, processing for synchronizing a vertical synchronization signal generated by the video synchronization signal generation unit 120 with a first synchronization pulse generated by the LTC generation unit 140 and the LTC transmission unit 150 is performed. Thus, the TC control unit 130 receives a vertical synchronization signal from the video synchronization signal generation unit 120. The TC control unit 130 includes a timer to count the time in order to generate a time code of the master camera 100. The TC control unit 130 transmits the count value of the timer to the LTC generation unit 140 at a timing synchronized with the vertical synchronization signal.

Based on the count value received from the TC control unit 130, the LTC generation unit 140 generates an LTC signal in the format shown in FIG. 3.

The LTC transmission unit 150 transmits an LTC signal generated by the LTC generation unit 140 to the slave camera 200. At the same time, the LTC transmission unit 150 detects the transmission completion timing of the synchronization pattern (Sync word) in the LTC signal, generates a pulse signal indicating the timing, and transmits the pulse signal to the video synchronization signal generation unit 120 as a first synchronization pulse signal. In FIG. 5, (B) shows the first synchronization pulse signal. As shown in (B) of FIG. 5, the first synchronization pulse signal is a signal of 30 Hz.

Based on the first synchronization pulse signal, as shown in (C) of FIG. 5, the video synchronization signal generation unit 120 generates a vertical synchronization signal synchronized with the first synchronization pulse signal. That is, the phase of the vertical synchronization signal is adjusted so that the phase of the vertical synchronization signal in the master camera 100 coincides with the phase of the first synchronization pulse signal. At this point, the vertical synchronization signal is generated at 60 Hz. At the same time, the video synchronization signal generation unit 120 also generates a horizontal synchronization signal in synchronization with the timing of the first synchronization pulse signal.

The video synchronization signal generation unit 120 transmits a vertical synchronization signal and a horizontal synchronization signal to the imaging unit 110 and the TC control unit 130. The imaging unit 110 performs an imaging operation in synchronization with the received vertical synchronization signal and horizontal synchronization signal.

Next, the operation on the slave camera 200 shown in FIG. 2 will be described. The LTC reception unit 250 of the slave camera 200 receives an LTC signal from the master camera 100. The LTC reception unit 250 detects the synchronization pattern from the received LTC signal, generates a pulse signal indicating the detection completion timing, and transmits the pulse signal to the video synchronization signal generation unit 220 as a second synchronization pulse signal. In FIG. 5, (D) shows an LTC signal received by the LTC reception unit 250 and in FIG. 5, (E) shows a second synchronization pulse signal generated from the received LTC signal. As shown in (E) of FIG. 5, the second synchronization pulse signal is a signal of 30 Hz.

The video synchronization signal generation unit 220 generates video synchronization signals (a vertical synchronization signal and a horizontal synchronization signal) in synchronization with the second synchronization pulse signal received from the LTC reception unit 250. That is, the phase of the vertical synchronization signal is adjusted so that the phase of the vertical synchronization signal in the slave camera 200 coincides with the phase of the second synchronization pulse signal. The video synchronization signal generation unit 220 transmits the video synchronization signal to the imaging unit 210 and the TC control unit 230. The imaging unit 210 performs an imaging operation in synchronization with the received vertical synchronization signal and horizontal synchronization signal.

Also, the LTC reception unit 250 extracts time code information (hour/minute/second, frame number) from the received LTC signal and transmits the extracted time code information to the TC control unit 230.

In addition to the time code information from the LTC reception unit 250, the TC control unit 230 also receives a vertical synchronization signal from the video synchronization signal generation unit 220. The TC control unit 230 generates a time code in the slave camera 200 using the time code information received from the LTC reception unit 250 in synchronization with the timing of the vertical synchronization signal. Accordingly, as shown in (A), (H), and (I) of FIG. 5, the time code of the slave camera 200 can be synchronized with the time code of the master camera 100. For example, the time code controlled by the TC control unit 230 is used to record video data generated by the imaging unit 210 in the slave camera 200.

As described above, a video synchronization signal in the slave camera 200 becomes a signal synchronized with the appearance timing of a synchronization pattern of the LTC signal received from the master camera 100. On the other hand, a video synchronization signal in the master camera 100 also becomes a signal synchronized with the appearance timing of a synchronization pattern of the same LTC signal. Therefore, the phase of the video synchronization signal is synchronized between the master camera 100 and the slave camera 200, and the phases of captured frames are synchronized between the master camera 100 and the slave camera 200a (see (A), (H), and (I) of FIG. 5).

While the slave camera 200 receives an LTC signal from the master camera 100, the TC control unit 230 generates a time code in the slave camera 200 using the time code information extracted from the LTC signal received as described above. The TC control unit 230 includes a timer inside and measures an elapsed time using the timer. When the slave camera 200a cannot receive an LTC signal from the master camera 100 after completion of the synchronous operation between the master camera 100 and the slave camera 200a, the TC control unit 230 of the slave camera 200 generates a time code using the time code information at the time when the LTC signal cannot be received and the count value from the time when the LTC signal cannot be received.

Therefore, when a synchronous operation is performed between the master camera 100 and the slave camera 200, the synchronous operation may be performed only once before shooting. Thereafter, in the slave camera 200, even when the LTC signal is not received from the master camera 100, the TC control unit 230 can generate a time code based on the count value of the timer.

Further, in the slave camera 200a, the shift of period of the clock signal may be adjusted according to the period of the second synchronization pulse. That is, when there is a difference between the period of the second synchronization pulse and the period of the clock signal, the VCXO 225 may adjust a shift of period of the clock signal so that the period of the clock signal in the slave camera 200a coincides with the period of the second synchronization pulse. Accordingly, even when there is a shift in period between the VCXO 125 in the master camera 100 and the VCXO 225 in the slave camera 200a, the shift can be adjusted so that accuracy of synchronization can be improved.

### [1-3. Effects, Etc.]

As described above, the imaging system 10 according to the present embodiment includes the master camera 100 (an example of a first imaging apparatus) that performs an imaging operation using a first video synchronization signal (an example of a first synchronization signal) and the slave camera 200 (an example of a second imaging apparatus) that performs an imaging operation using a second video synchronization signal (an example of a second synchronization signal). The master camera 100 transmits an LTC signal (an example of a time code signal) including time code information and a synchronization pattern (Sync word) for detecting the time code information to the slave camera 200. The master camera 100 generates a first video synchronization signal so as to be synchronized with the synchronization pattern contained in the LTC signal transmitted to the slave camera 200. The slave camera 200 generates a second video synchronization signal so as to be synchronized with the synchronization pattern contained in the LTC signal received from the master camera 100.

With this configuration, in both of the master camera 100 and the slave camera 200, the phase of a video synchronization signal is adjusted based on the synchronization pattern in a common LTC signal so that the phases of the video synchronization signals between the master camera 100 and the slave camera 200 can be accurately synchronized. Therefore, it is possible to perform a shooting operation in which the exposure timing is synchronized between the master camera 100 and the slave camera 200.

In addition, only an LTC signal needs to be communicated between the master camera 100 and the slave camera 200 and thus, it is sufficient to prepare one cable for synchronous operation.

Further, common software for generating a video synchronization signal from a synchronization pulse signal can be used between the master camera 100 and the slave camera 200a and thus, the manufacturing process can be simplified and the manufacturing cost can be reduced.

More specifically, the slave camera 200 (an example of the imaging apparatus) includes the imaging unit 210 (an example of the imager) that performs an imaging operation according to a video synchronization signal (an example of the synchronization signal), the LTC reception unit 250 (an example of a receiver) that receives an LTC signal (an example of the time code signal) including time code information and a synchronization pattern for detecting the time code information from the master camera 100 (an example of the other imaging apparatus), the video synchronization signal generation unit 220 (an example of a synchronization signal generator) that generates a video synchronization signal so as to be synchronized with the timing of a synchronization pattern contained in the received time code signal, and the TC control unit 230 (an example of a time code controller) that generates a time code based on the video synchronization signal and the received time code information.

With this configuration, the slave camera 200 can adjust the phase of a video synchronization signal in synchronization with a synchronization pattern in the LTC signal received from the master camera 100 so that the phase can be synchronized with a vertical synchronization signal of the master camera 100.

More specifically, the master camera 100 (an example of the imaging apparatus) includes the imaging unit 110 (an example of the imager) that performs an imaging operation according to a video synchronization signal (an example of the synchronization signal), the LTC generation unit 140 (an example of a time code signal generator) that generates an LTC signal including time code information and a synchronization pattern for detecting the time code information, the LTC transmission unit 150 (an example of a transmitter) that transmits an LTC signal to the slave camera 200, and the video synchronization signal generation unit 220 (an example of the synchronization signal generator) that generates a video synchronization signal so as to be synchronized with the timing of a synchronization pattern contained in the time code signal to be transmitted.

With this configuration, the master camera 100 can adjust the phase of a video synchronization signal in synchronization with a synchronization pattern in the LTC signal transmitted to the slave camera 200 so that the phase can be synchronized with the video synchronization signal of the slave camera 200.

The present disclosure provides an imaging apparatus capable of accurately synchronizing capturing timings of images among a plurality of imaging apparatuses.

An imaging apparatus according to a first aspect of the present disclosure includes an imaging unit that performs an imaging operation according to a synchronization signal, a reception unit that receives a time code signal containing time code information and a synchronization pattern for detecting the time code information from another imaging apparatus, a synchronization signal generation unit that generates the synchronization signal so as to be synchronized with a timing of the synchronization pattern contained in the time code signal received, and a time code control unit that generates a time code based on the synchronization signal and the time code information received.

An imaging apparatus according to a second aspect of the present disclosure includes an imaging unit that performs an imaging operation according to a synchronization signal, a time code signal generation unit that generates a time code signal containing time code information and a synchronization pattern for detecting the time code information, a transmission unit that transmits the time code signal to another imaging apparatus, and a synchronization signal generation unit that generates the synchronization signal so as to be synchronized with a timing of the synchronization pattern contained in the time code signal transmitted.

An imaging system according to a third aspect of the present disclosure includes a first imaging apparatus that performs an imaging operation using a first video synchronization signal and a second imaging apparatus that performs the imaging operation using a second video synchronization signal. The first imaging apparatus transmits a time code signal (LTC signal) containing time code information and a synchronization pattern for detecting the time code information to the second imaging apparatus. The first imaging apparatus generates the first video synchronization signal so as to be synchronized with the synchronization pattern contained in the time code signal transmitted to the second imaging apparatus. The second imaging apparatus generates the second video synchronization signal so as to be synchronized with the synchronization pattern contained in the time code signal received from the first imaging apparatus.

According to the present disclosure, phases of synchronization signals (for example, video synchronization signals) can coincide with each other among a plurality of imaging apparatuses so that capturing timings of images can be accurately synchronized among the plurality of imaging apparatuses.

### Other Embodiments

As described above, the first embodiment has been described as an illustration of the technology disclosed in the present application. However, the technology in the present disclosure is not limited to this, and can also be applied to embodiments in which changes, substitutions, additions, omissions, or the like are made as appropriate. In addition, it is also possible to combine the respective components described in the first embodiment to form a new embodiment. Thus, other embodiments will be illustrated below.

In the above embodiment, the number of slave cameras is two, but the number of slave cameras is not limited thereto. The number of slave cameras may be one or three or more.

In the above embodiment, the LTC signal is used as an example of the time code signal, but the time code signal is not limited thereto. A signal containing a time code and also containing a synchronization pattern periodically appearing in synchronization with a frame can be used as a time code signal.

As described above, an embodiment has been described as an illustration of the technology in the present disclosure. To that end, the accompanying drawings and detailed description have been provided.

Therefore, among components described in the accompanying drawings and detailed description, not only essential components for solving the problem, but also components that are not essential for solving the problem are included to illustrate the technology. For this reason, the fact that these non-essential components are described in the accompanying drawings or detailed description should not immediately lead to the recognition that these non-essential components are essential.

Further, the above embodiment is provided to illustrate the technology in the present disclosure and thus, it is possible to make various changes, substitutions, additions, omissions, or the like within the scope of claims or equivalents thereof.

The present disclosure can be applied to an imaging apparatus that captures an image in synchronization with another imaging apparatus.

Obviously, numerous modifications and variations of the present invention are possible in light of the above teachings. It is therefore to be understood that within the scope of the appended claims, the invention may be practiced otherwise than as specifically described herein.

What is claimed is:

1. An imaging apparatus comprising:
an imager to perform an imaging operation according to a synchronization signal;
a receiver to receive a time code signal including time code information and a synchronization pattern for detecting the time code information from another imaging apparatus;
a synchronization signal generator to generate the synchronization signal so as to be synchronized with a timing of the synchronization pattern included in the time code signal received; and
a time code controller to generate a time code based on the synchronization signal and the time code information received.

2. The imaging apparatus according to claim 1, further comprising:
a clock adjuster to adjust a period of a clock signal, wherein
the synchronization signal generator generates the synchronization signal based on the clock signal, and
the clock adjuster adjusts the period of the clock signal based on a detection interval of the synchronization pattern.

3. The imaging apparatus according to claim 1, wherein
the time code controller has a timer to count an elapsed time, and
the time code controller generates the time code based on the time code at a time when the time code signal has been last received and a count value of the timer in a case where the receiver does not receive the time code signal from the another imaging apparatus.

4. The imaging apparatus according to claim 1, wherein the time code signal includes a longitudinal time code (LTC) signal defined by an SMPTE 12 standard.

5. An imaging apparatus comprising:
an imager to perform an imaging operation according to a synchronization signal;
a time code signal generator to generate a time code signal including time code information and a synchronization pattern for detecting the time code information;
a transmitter to transmit the time code signal to another imaging apparatus; and
a synchronization signal generator to generate the synchronization signal so as to be synchronized with a timing of the synchronization pattern included in the time code signal transmitted.

6. The imaging apparatus according to claim 5, wherein the time code signal includes a longitudinal time code (LTC) signal defined by an SMPTE 12 standard.

7. An imaging system comprising:
a first imaging apparatus to
perform an imaging operation according to a first video synchronization signal;
transmit a time code signal including time code information and a synchronization pattern for detection of the time code information; and
generate the first video synchronization signal so as to be synchronized with the synchronization pattern included in the time code signal; and
a second imaging apparatus to
perform the imaging operation according to a second video synchronization signal; and
generate the second video synchronization signal so as to be synchronized with the synchronization pattern included in the time code signal received from the first imaging apparatus.
